(19) United States
(12) Patent Application Publication
(10) Pub. No.: US 2019/0147481 A1
(43) Pub. Date: May 16, 2019

(54) SYSTEM AND METHOD FOR SECURE DELIVERY AND PAYMENT OF A PRODUCT OR A SERVICE

(71) Applicant: Vikalp Shrivastava, Gwalior (IN)

(72) Inventor: Vikalp Shrivastava, Gwalior (IN)

(21) Appl. No.: 16/186,354

(22) Filed: Nov. 9, 2018

Related U.S. Application Data
(60) Provisional application No. 62/584,415, filed on Nov. 10, 2017.

(51) Int. Cl. G06Q 30/02; G06Q 20/40; G06Q 20/02; G06Q 20/32

(52) U.S. Cl. CPC G06Q 30/0235; G06Q 20/4014; G06Q 20/3274; G06Q 30/0282; G06Q 20/027

(57) ABSTRACT

A processor implemented method for secure delivery of a product or service is provided. The method includes (i) generating a first database by obtaining information regarding location as selected by a first user, (ii) authenticating a second user at a second user device by verifying user identity and bank details, to generate time restricted offers from the second device, (iii) verifying an assistant at a third device, (iv) communicating the time restricted offers to the first device based on the preference of the first user, (v) obtaining a product or a service request from the first device of the first user, (vi) obtaining payment from the first user at the first device for the selected product or service and transferring the payment to an intermediary payment bank and (vii) generating a unique image code when a secure payment is received from the first user for the selected product or service.

### CROSS-REFERENCE TO RELATED APPLICATIONS

This patent application claims priority to pending U.S. provisional patent application No. 62/584,415 filed on Nov. 10, 2017, the complete disclosures of which, in their entireties, are hereby incorporated by reference.

### BACKGROUND

### Technical Field

Embodiments of this disclosure generally relate to a secure delivery and payment, more particularly, to a system and method for secure delivery and payment of one or more products or services to customers.

### Description of the Related Art

Many consumers find time restricted offers as a part of their shopping regiment. Nowadays time restricted offers may be in a paper form or an electronic form, and the time restricted offers are distributed to the customers via emails (For example junk mail), or paper communications (For example, newspaper inserts, flyers, and the like), or online offers such as web banners (For example pop-up and other presentations) and so forth.

A variety of time restricted offers, daily deals, and gift cards causes additional problems and frustrations for consumers that ultimately lead to missed savings. There is no way to consolidate all paper and electronic time restricted offers in a single place, easily and readily accessible to the customers from anywhere. Further, finding, tracking, and managing time restricted offers, by product, expiration date, or store, is tedious and time-consuming.

There is no solution that provides a system or an application, or a device that enable a user to promote or sell a brand or product in conjunction with the user's activity of sharing of a photo. The sharing of photos are increasingly used by any person as a part of ongoing communication with his/her connections, these photos are not associated with any systemic capabilities for brand or product or service time restricted offer.

In recent days, product and service related companies and marketers are always looking for an efficient and innovative way to transfer their product or service time restricted offer to the consumers in the most effective manner. In a digital world, product and service related companies may reach the people very easily via newspapers, E-papers, magazines and television advertisements, email, text message via phone, banner ads in web browsers, text messaging apps and the like. People have so many bypass ways (restrictions) to get rid from the advertisements (e.g., add blocker, do not call, do not disturb and the like.). Online advertisements are very big business in the current scenario and expensive. The product and service related companies and marketers are trying to reach the customers without knowing customer's preferences. For example, the product and service related company is broadcasting their advertisement in a TV channel, but viewer may not be the potential consumer. Based on the above strategy the product and service related companies spending a large amount of time and money on the advertisement that may not result in providing potential consumers. Many because the companies are aware of the preferences of the customers. Hence, in the digital world reaching the potential consumers is a difficult task. Also, from consumers point of view, receiving delivery of wrong product or service or not within time is an issue. On Promoters side, issue is returns and limited reach of the delivery.

Accordingly, there remains a need for a system and method to provide time restricted offers of the product or services to potential consumers in an efficient way.

### SUMMARY

In view of the foregoing, an embodiment herein provides a processor implemented method for enabling secure delivery and secure payment of a product or a service. The method includes steps of (i) generating a first database by obtaining information regarding location as selected by a first user, (ii) authenticating a second user at a second user device by verifying user identity and bank details, to generate time restricted offers from the second device, (iii) verifying an assistant at a third device, (iv) communicating the time restricted offers to the first device based on the preference of the first user, (v) obtaining a product or a service request from the first device of the first user, (vi) obtaining payment from the first user at the first device for the selected product or service and transferring the payment to an intermediary payment bank, (vii) generating a unique image code when a secure payment is received from the first user for the selected product or service, (viii) communicating the unique image code to (a) the first device of the first user and (b) the second device of the second user or (c) the third device of the assistant, (ix) verifying the unique image code by an image identification on the first device by the second or the third device when the selected product or service is delivered to the first user, (x) notifying the second user when the unique image code in the first device matches with a second delivery image code on the second device or the third device and processing the payment to the second user from the intermediary bank account and (xi) enabling ratings of the second user or the assistant to the first user and generating a fourth database with the ratings and credits for the first user, the second user and the assistant. The first user is authenticated at a first device by verifying user identity and bank details of the first user. An identity and bank details of the verified assistant are stored at a third database of verified assistants.

In an embodiment, the method further includes obtaining an assistant request from the first device; and communicating the assistant request to at least one of the third device within a selected location radius as provided by the first user when the second user do not provide secure delivery of the product or the service for the selected time restricted offer or within the selected location radius.

In another embodiment, the method further includes notifying the third device and processing the payment to the verified assistant from the intermediary bank account when the unique image code matches with a second delivery image code generated on the third device.

In yet another embodiment, the method further includes receiving the product or the service request from the first device and communicating the product or service request to at least one second device or at least one third device when said product or service is not available for an instant time.

In yet another embodiment, the method further includes receiving a product or a service price suggestion from the first device and displayed to the second device and the third device.

In yet another embodiment, the method further includes enabling the assistant to (i) edit and repost the time restricted offer or (ii) post a new time restricted offer on at least one the third device for enabling the first user to select the product or service offered by the time restricted offer, wherein the first user is in first user selected location radius or chooses to see the posts or reposts made by the assistant.

In yet another embodiment, the method further includes reverting the unique image code to the first user when the user selected product or service is not delivered by the second user or by the assistant and retain the payment made by the first user in the intermediary bank account and the database maintains a credit for the first user equal to the payment made by the first user.

In one aspect, a system of automated secure delivery and secure payment of a product or a service is provided. The system includes a memory that stores a set of instructions; and a processor that executes the set of instructions and is configured to (i) generate a first database by obtaining information regarding location as selected by a first user, (ii) authenticate a second user at a second user device by verifying user identity and bank details, to generate time restricted offers from the second device, (iii) verify an assistant at a third device, (iv) communicate the time restricted offers to the first device based on the preference of the first user, (v) obtain a product or a service request from the first device of the first user, (vi) obtain payment from the first user at the first device for the selected product or service and transfer the payment to an intermediary payment bank, (vii) generate a unique image code when a secure payment is received from the first user for the selected product or service, (viii) communicate the unique image code to (a) the first device of the first user and (b) the second device of the second user or (c) the third device of the assistant, (ix) verify the unique image code by an image identification on the first device by the second or the third device when the selected product or service is delivered to the first user, (x) notify the second user when the unique image code in the first device matches with a second delivery image code on the second device or the third device and processing the payment to the second user from the intermediary bank account and (xi) enable ratings of the second user or the assistant to the first user and generating a fourth database with the ratings and credits for the first user, the second user and the assistant. The first user is authenticated at a first device by verifying user identity and bank details of the first user. An identity and bank details of the verified assistant are stored at a third database of verified assistants.

In an embodiment, the processor further configured to obtain an assistant request from the first device and communicate the assistant request to at least one of the third device within a selected location radius as provided by the first user when the second user do not provide secure delivery of the product or the service for the selected time restricted offer or within the selected location radius.

In another embodiment, the processor further configured to notify the third device and process the payment to the verified assistant from the intermediary bank account when the unique image code matches with a second delivery image code generated on the third device.

In yet another embodiment, the processor further configured to receive the product or the service request from the first device and communicating the product or service request to at least one of (i) second device or the third device when the product or service is not available for an instant time.

In yet another embodiment, the processor further configured to receive a product or a service price suggestion from the first device and displayed to the second device and the third device.

In yet another embodiment, the processor further configured to enable the assistant to (i) edit and repost the time restricted offer or (ii) post a new time restricted offer on at least one the third device for enabling the first user to select the product or service offered by the time restricted offer. The first user is in first user selected location radius or chooses to see the posts or reposts made by the assistant.

In yet another embodiment, the processor further configured to revert the unique image code to the first user when the selected product or service is not delivered by the second user or by the assistant and retain the payment made by the first user in the intermediary bank account and the fourth database maintains a credit for the first user equal to the payment made by the first user.

In another aspect, one or more non-transitory computer readable storage mediums storing one or more sequences of instructions, which when executed by one or more processors, causes a processor implemented method enabling secure delivery and secure payment of a product or a service is provided. The one or more non-transitory computer readable storage mediums includes the steps of: (i) generating a first database by obtaining information regarding location as selected by a first user, (ii) authenticating a second user at a second user device by verifying user identity and bank details, to generate time restricted offers from the second device, (iii) verifying an assistant at a third device, (iv) communicating the time restricted offers to the first device based on the preference of the first user, (v) obtaining a product or a service request from the first device of the first user, (vi) obtaining payment from the first user at the first device for the selected product or service and transferring the payment to an intermediary payment bank, (vii) generating a unique image code when a secure payment is received from the first user for the selected product or service, (viii) communicating the unique image code to (a) the first device of the first user and (b) the second device of the second user or (c) the third device of the assistant, (ix) verifying the unique image code by an image identification on the first device by the second or the third device when the selected product or service is delivered to the first user, (x) notifying the second user when the unique image code in the first device matches with a second delivery image code on the second device or the third device and processing the payment to the second user from the intermediary bank account and (xi) enabling ratings of the second user or the assistant to the first user and generating a fourth database with the ratings and credits for the first user, the second user and the assistant. The first user is authenticated at a first device by verifying user identity and bank details of the first user. An identity and bank details of the verified assistant are stored at a third database of verified assistants.

In an embodiment, the method further includes obtaining an assistant request from the first device; and communicating the assistant request to at least one of the third device within a selected location radius as provided by the first user when the second user do not provide secure delivery of the product or the service for the selected time restricted offer or within the selected location radius. In another embodiment, the method further includes notifying the third device and process the payment to the verified assistant from the intermediary bank account when the unique image code matches with the second delivery image code generated on the third device.

In yet another embodiment, the method further includes receiving the product or the service request from the first device and communicating the product or service request to at least one of (i) second device or the third device when the product or service is not available for an instant time.

In yet another embodiment, the method further includes enabling the assistant to (i) edit and repost the time restricted offer or (ii) post a new time restricted offer on at least one the third device for enabling the first user to select the product or service offered by the time restricted offer. The first user is in first user selected location radius or chooses to see the posts or reposts made by the assistant.

In yet another embodiment, the method further includes reverting the unique image code to the first user when the selected product or service is not delivered by the second user or by the assistant and retaining the payment made by the first user in the intermediary bank account and the fourth database maintains a credit for the first user equal to the payment made by the first user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of enabling secure delivery and secure payment of a product or a service according to an embodiment herein;

FIG. 2 illustrates an exploded view of a first device of FIG. 1 according to an embodiment herein;

FIG. 3 illustrates an exploded view of a second device of FIG. 1 according to an embodiment herein;

FIG. 4 illustrates an exploded view of a third device of FIG. 1 according to an embodiment herein;

FIG. 5 illustrates an exploded view of a payment server of FIG. 1 according to an embodiment herein;

FIG. 6 illustrates a flow diagram of method for utilizing time restricted offers in the first device of FIG. 1 according to an embodiment herein;

FIG. 7 illustrates a flow diagram of method for promoting products in the second device of FIG. 1 according to an embodiment herein;

FIG. 8 illustrates a flow diagram of method for processing time restricted offers in the third device of FIG. 1 according to an embodiment herein;

FIG. 9 illustrates a flow diagram of method for enabling secure delivery and secure payment of a product or a service according to an embodiment herein;

FIG. 10 is an interaction diagram illustrating a process of the first user interacting with the first device according to an embodiment herein;

FIG. 11 is an interaction diagram illustrating a process of the assistant interacting with the third device according to an embodiment herein;

FIG. 12 is an interaction diagram illustrating a process of the second user 110 interacting with the second device according to an embodiment herein;

FIG. 13 illustrates an exploded view of the secure delivery and payment server of FIG. 1 according to an embodiment herein; and

FIG. 14 illustrates a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein

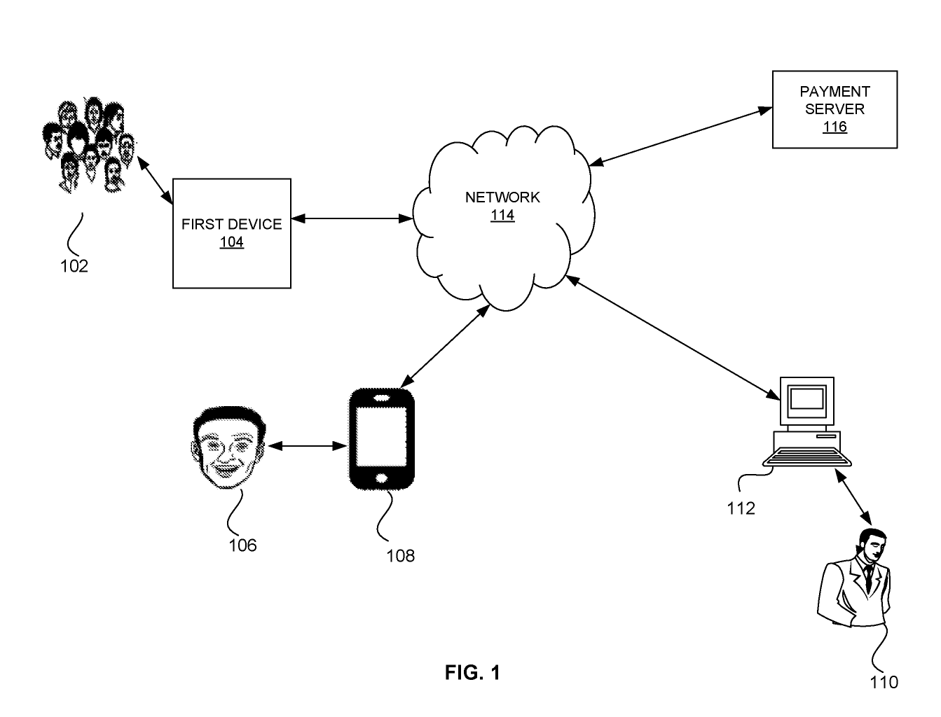

As mentioned, there remains a need there remains a need for a system and method for enabling secure delivery and secure payment of a product or a service to customers. Referring now to the drawings, and more particularly to FIG. 1 through FIG. 14, where similar reference characters denote corresponding features consistently throughout the figures, there are shown preferred embodiments.

FIG. 1 illustrates a system view of for enabling secure delivery and secure payment of a product or a service according to an embodiment herein. The system view includes a first user 102, a first device 104, a second user 106, a second device 108, an assistant 110, a third device 112, a network 114, and a payment server 116. The payment server 118 generates a first database by obtaining information regarding location as selected by the first user 102. In an embodiment, the first user 102 is authenticated at the first device 104 by verifying user identity and bank details of the first user 102. The payment server 116 authenticates the second user 106 at the second user device 108 by verifying user identity and bank details, to generate time restricted offers from the second device 108. An identity and bank details of at least one second user are stored at a second database of verified second users. The payment server 116 verifies the assistant 110 at the third device 112. An identity and bank details of the verified assistant are stored at a second database of verified assistants. The payment server 116 communicates the time restricted offers to the first device 104 based on the preference of the first user 102.

The payment server 116 obtains a product or a service request from the first device 104 of the first user 102. The payment server 116 obtains payment to an intermediary payment bank from the first user 102 at the first device 104 for the selected product or service. The payment server 116 generates a unique image code when a secure payment is received from the first user 102 for the selected product or service. The payment server 116 communicates (i) the unique image code to the first device 104 of the first user 102 and (ii) the second device 108 of the second user 106 or (iii) the third device 112 of the assistant 110 as a first delivery image code. The payment server 116 verifies the unique image code by an image identification on the first device 104 using the second device 108 or the third device 112 when the selected product or service is delivered to the first user 102. The payment server 116 notifies the second user 106 when the unique image code in the first device 104 matches with a second delivery image code on the second device 108 or the third device 112 and processes the payment to the second user 106 from the intermediary bank account.

The payment server 116 enables ratings of the second user 106 or the assistant 110 to the first user 102 and generates a fourth database with the ratings and credits for the first user 102, the second user 106 and the assistant 110. In one embodiment, the first device 104, the second device 108 and the third device 116 may be a mobile device, a wireless device, a personal computer, a cell phone, a netbook, a smart phone, a tablet device, a notebook, a personal digital assistant, an internet phone, a cable internet device, a satellite internet device, an internet television, a portable internet access device etc. In a non-limiting example, there may be one or more first users 102, one or more second users 108, and one or more assistants 110. In one embodiment, the network 114 may be a wired network or a wireless network.

The second user 106 may take one or more images of products and upload the one or more product images with a predefined format in the second device 108. The second user 106 may choose predefined criteria in the second device 108 to classify the one or more product images and time restricted offers associated with the one or more product images.

The second device 108 communicates the time restricted offers along with the one or more product images to the payment server 116. The payment server 116 publishes the time restricted offers along with the one or more product images to the first device 104. The first user 102 may order or purchase time restricted offers for the product or the service the first device 104.

The third device 112 receives an information associated with the time restricted offer products from the first device 104. The assistant 110 may send the one or more product images along with the time restricted offers to the payment server 116. In an embodiment, the assistant 110 may edit the time restricted offers. The assistant 110 may search and view number of followers of the second user 106 and ratings of the second user 106. The assistant 110 may also view the ratings of the second user 106 received from the first user 102.

The first user 102 may provide one or more preferences using the first device 104. The first device 104 searches the time restricted offers products based on the one or more preferences. In one embodiment, the time restricted offers are displayed in the first device 104 based on the second user 106 who is already followed by the first user 102. The second user 106 may deliver the time restricted offer products to the first user 102. The second user 106 or the first user 102 may view all time restricted offers in the payment server 116 which is provided by the assistant 110.

The second user 106 may obtain a notification in the second device 108 about activities of the first user 102, and the assistant 110. The second user 106 may re-share the time restricted offers if it is available. The second user 106 may communicate the time restricted offers with the one or more first user 102 and the assistant 110.

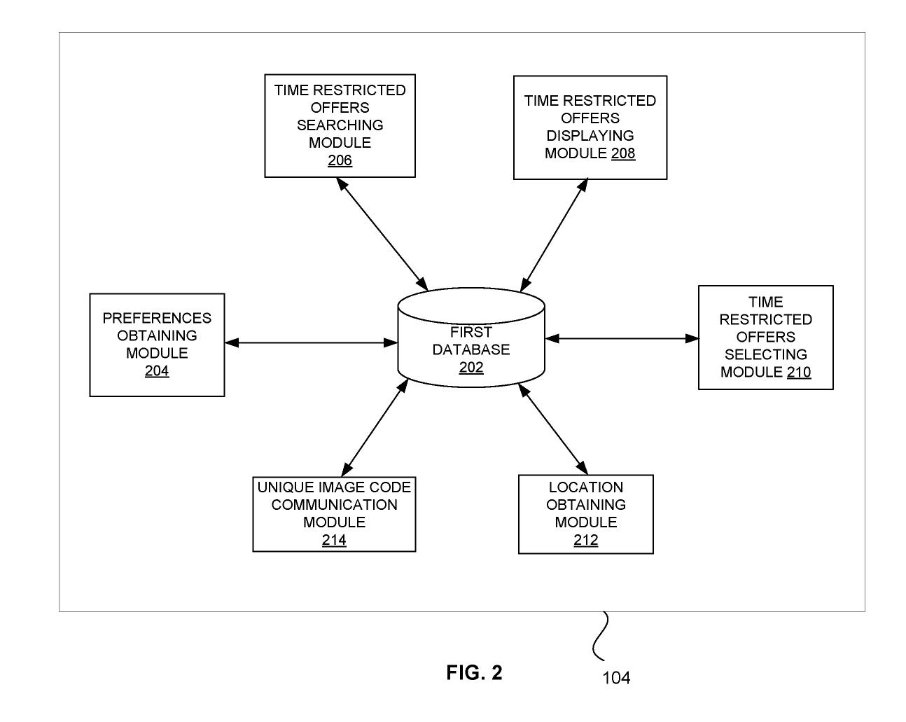

FIG. 2 illustrates an exploded view of the first device 104 of FIG. 1 according to an embodiment herein. The exploded view of the first device 104 includes a first database 202, preferences obtaining module 204, a time restricted offers searching module 206, a time restricted offers displaying module 208, a time restricted offer selecting module 210, a location obtaining module 212, and a unique image code communication module 214. The preferences obtaining module 204 obtains the one or more preferences the first user 102. The time restricted offers searching module 206 searches the time restricted offers related to the one or more preferences of the product or service based on the one or more preferences of the first user 102. The time restricted offers displaying module 208 displays the time restricted offers to the first user 102 when the one or more preferences are met with the time restricted offers.

The time restricted offer selecting module 210 selects specific time restricted offer from the time restricted offers posted by the second user 106 or the assistant 110. The location obtaining module 212 obtains the location associated with the selected time restricted offer product or service or the second user 106. The unique image code communication module 214 communicates the unique image code associated with an order of the time restricted offer to the second device 108 or the third device 112.

In one embodiment, the first user 102 views the time restricted offers by the second user 106 in a form of a bubble view in the first device 104. The bubble view of each time restricted offers may vary based on the offers/time restricted offers. The color of the bubble may vary based on at least one of product type, location, total price and the like. The shape of the bubble associated with the time restricted offers may vary based on the offers/time restricted offers. The first user 102 may chat with the second user 106 if the first user 102 needs any order to be delivered which cannot be delivered by the assistant 110. The first user 102 may provide his/her preference in the first device 104 as to what areas he/she is interested in, once selection of the preferences is done, the first device 104 searches the relative offers and will show offers in the bubble view. The bubble view may be on a MAP with a 50% or 40% bubble tip.

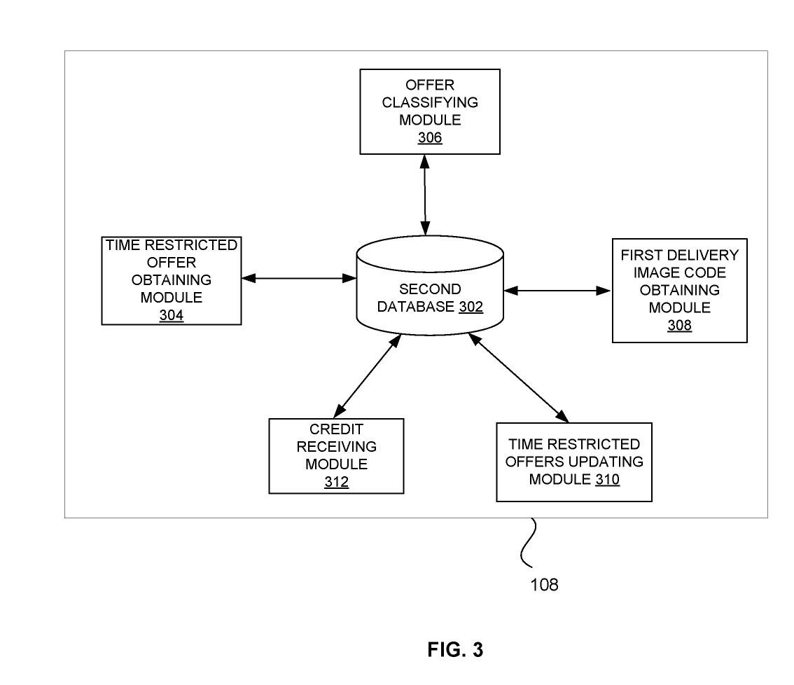

FIG. 3 illustrates an exploded view of the second device 108 of FIG. 1 according to an embodiment herein. The exploded view of the second device 108 includes a second database 302, a time restricted offer obtaining module 304, an offer classifying module 306, a first delivery image code obtaining module 308, a time restricted offers updating module 310, and a credit receiving module 312. The time restricted offer obtaining module 304 obtains the one or more images of the time restricted offer. Time restricted offer may be obtained by capturing an image of relevant data. The classifying module 306 classifies the time restricted offers with a predefined criteria which is then notified to the first user 102 or the assistant 110 with the unique image. The first delivery image code obtaining module 308 uploads the one or more images with a first delivery image code along with the location of the first user 102 when the time restricted offer is selected by the first user 102 and payment is made for the purchase by the first user 102 to an intermediary bank.

The time restricted offers updating module 310 updates the time restricted offers in the third device 112. The credit receiving module 312 receives the rewards for the one or more products or services associated with the time restricted offers by the first user 102 on successful, delivery of the product or service as understood by matching of the unique image code on the first device 104 with the second delivery code that is displayed on at least one of (i) the second device 108 or (ii) the third device 112.

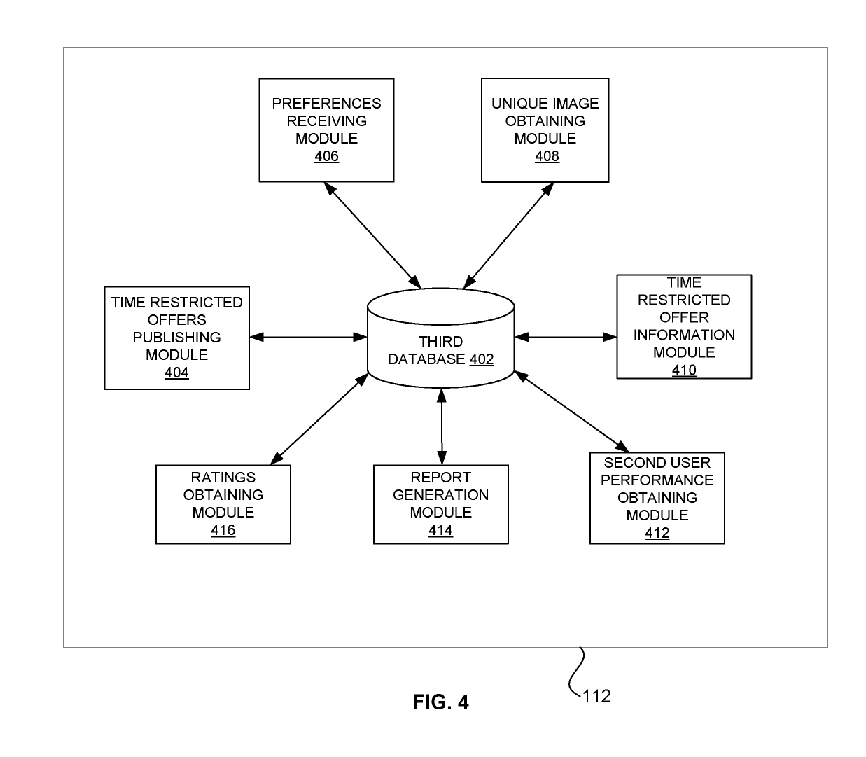

FIG. 4 illustrates an exploded view of the third device 112 of FIG. 1 according to an embodiment herein. The exploded view of the third device 112 includes a third database 402, a time restricted offers publishing module 404, preferences receiving module 406, a unique image code obtaining module 408, a time restricted offer information obtaining module 410, a second user performance obtaining module 412, a report generation module 414 and ratings obtaining module 416. The time restricted offers publishing module 404 publishes the images of the time restricted offer product with the predefined format. The preferences receiving module 406 receives the one or more preferences from the first user 102. The unique image code obtaining module 408 obtains the unique image code for the selected time restricted offer product from the first user 102. The time restricted offer information obtaining module 410 obtains an information (e.g., banking details, email address, phone number etc.) of number of time restricted offers claimed. The second user performance obtaining module 412 obtains a performance information of the second user 106 for selling the time restricted offer product.

The report generation module 414 generates a report corresponding to the time restricted offer product. The ratings obtaining module 416 obtains ratings from the first user 102 or the second user 106. The profile of the second user 106 defines what area/circle and category the second user 106 wishes to sell in. The second device 108 may enable the second user 106 to obtain details about if the first 102 has paid for the product or not. The second device 108 may enable the second user 106 to obtain details about the time restricted offers posted till date and is able to edit the time restricted offers. The second device 108 may enable the second user 106 to obtain details about all the time restricted offers that accepted and paid by a shopper and status (e.g., delivered/pending). The second user 106 may change status from pending to delivered in the payment server 116 once obtain the first delivery code from the first user 102 for the product which already received from the first user 102. The delivery is complete when the unique image code on the first device 104 matches with the second delivery code on the second device 108 or the third device 112 scanned with a device camera. The unique image code is generated when the payment is received at the intermediary bank account of the first user 102 or when intermediary bank account has credit for equal to or more than the purchase order that the first user 102 has made.

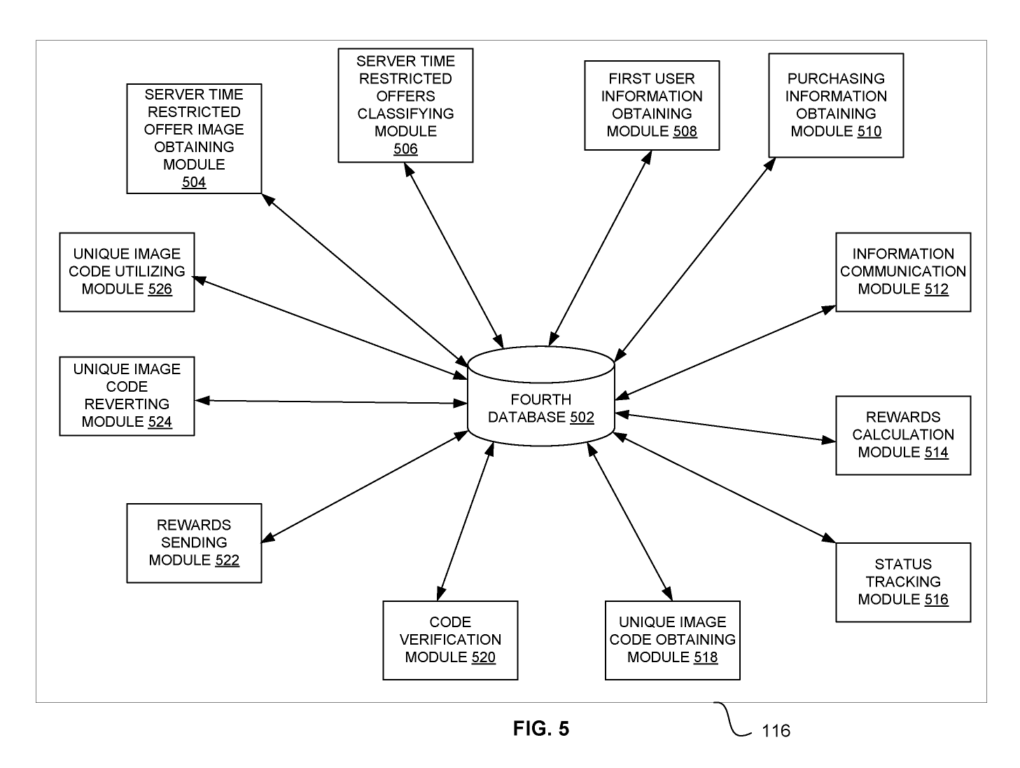

FIG. 5 illustrates an exploded view of the payment server 116 of FIG. 1 according to an embodiment herein. The exploded view includes a fourth database 502, a server time restricted offer image obtaining module 504, a server time restricted offers classifying module 506, a first user information obtaining module 508, a purchasing information obtaining module 510, an information communication module 512, a rewards calculation module 514, a status tracking module 516, a unique image code obtaining module 518, a code verification module 520, a rewards sending module 522, a unique image code reverting module 524, and a unique image code utilizing module 526. The server time restricted offer image obtaining module 504 obtains the one or more images of the time restricted offer product. The server time restricted offers classifying module 506 classifies the time restricted offers with the predefined criteria.

The first user information obtaining module 508 receives an information associated with number of views of the time restricted offers by the first user 102. The purchasing information obtaining module 510 receives a purchasing information of the time restricted offers from the first user 102. The information communication module 512 communicates an information of the second user 106 or the assistant 110 to the first user 102. The rewards calculation module 514 calculates rewards to the second user 106 for every purchasing of the time restricted offer product and credits it to the intermediary bank account of the second user 106. The status tracking module 516 tracks the status of the time restricted offer product. The unique image code obtaining module 518 obtains the unique image code from the second user 106 using the second device 108.

The code verification module 520 verifies the unique image code with the second delivery image code displayed on the second device 108 or the third device 112 in order to complete a delivery process. The rewards sending module 522 sends rewards to the second user 106 when the unique image code is matched with the second delivery image code with the credit equal to the selling cost of the product or the service selected and paid by the first user 102. The unique image code reverting module 524 reverts the unique image code to the first user 102 when he/she cancels an order or product or service not delivered or wrongly delivered. The unique image code utilizing module 526 enables the first user 102 to utilize the unique image code for next orders. In one embodiment, the assistant 110 may edit or delete the time restricted offers any time. If the assistant 110 ready to provide online order but do not want to support delivery in that case the assistant 110 may search the second user 106 to deliver the product. The assistant 110 may define where the product needs to be delivered with details of the product and then search for the second user 106 who can provide that product or service delivery. The assistant 110 may view complete chat history with respect to any of the second user 106.

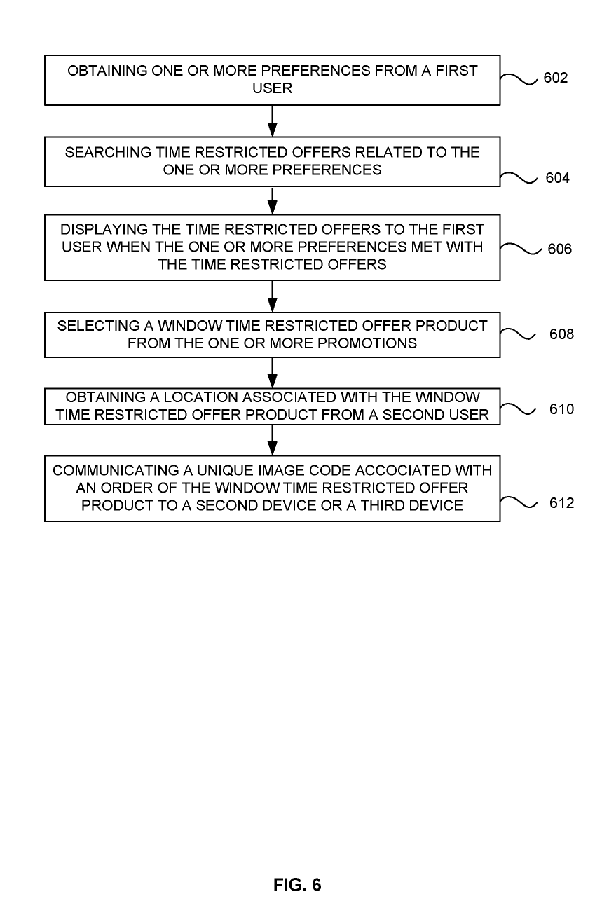

FIG. 6 illustrates a flow diagram of method for utilizing time restricted offers in the first device 104 of FIG. 1 according to an embodiment herein. At step 602, the first device 104 obtains the one or more preferences from the first user 102. At step 604, the first device 104 searches the time restricted offers related to the one or more preferences. At step 606, the first device 104 displays the time restricted offers to the first user 102 when the one or more preferences are met with the time restricted offers. At step 608, the first device 104 selects the window time restricted offer product from the time restricted offers. At step 610, the first device 104 obtains a location associated with the window time restricted offer product from the second user 106. At step 612, the first device 104 communicates a unique image code associated with an order of the window time restricted offer product to the second device 108 or the third device 112.

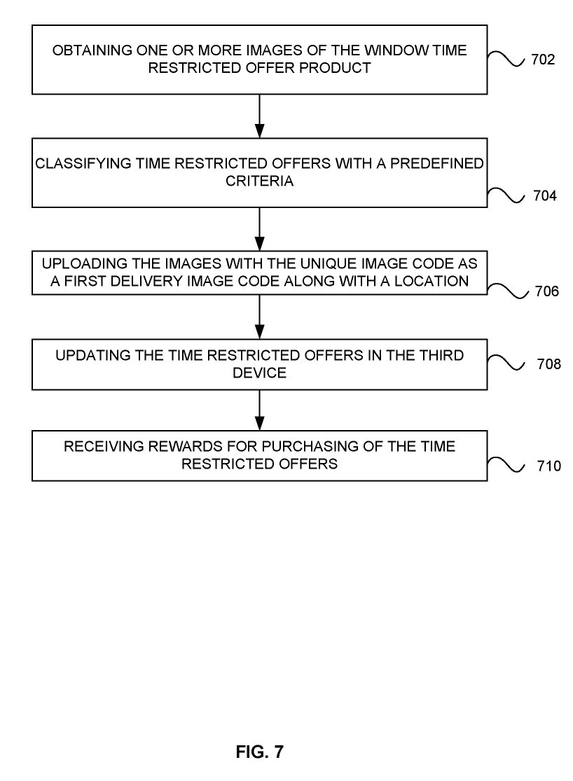

FIG. 7 illustrates a flow diagram of method for promoting products in the second device 108 of FIG. 1 according to an embodiment herein. At step 702, the second device 108 obtains the one or more images of the window time restricted offer product. At step 704, the second device 108 classifies the time restricted offers with a predefined criteria. At step 706, the second device 108 uploads the images with the unique image code as a first delivery image code along with the location. At step 708, the second device 108 updates the time restricted offers in the third device 112. At step 710, the second device 108 receives the rewards by purchasing of the time restricted offers.

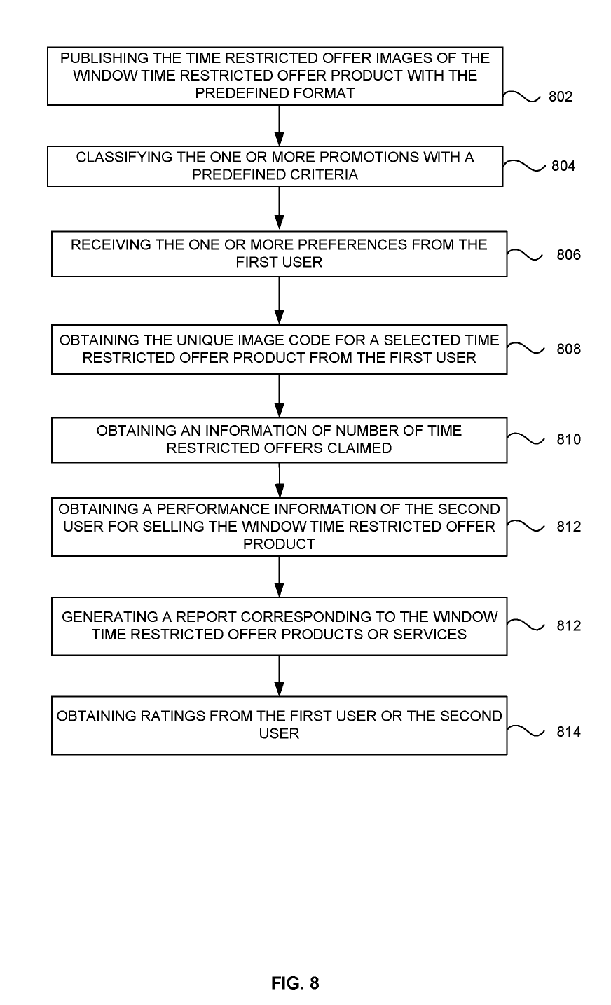

FIG. 8 illustrates a flow diagram of method for processing time restricted offers in the third device 112 of FIG. 1 according to an embodiment herein. At step 802, the third device 112 publishes the time restricted offer images of the window time restricted offer product with the predefined format. At step 804, the third device 112 receives the one or more preferences from the first user 102. At step 806, the third device 112 obtains the unique image code for a selected time restricted offer product from the first user 102. At step 808, the third device 112 obtains an information of number of time restricted offers claimed. At step 810, the third device 112 obtains a performance information of the second user 106 for selling the window time restricted offer product. At step 812, the third device 112 generates a report corresponding to the window time restricted offer products or services. At step 814, the third device 112 obtains ratings from the first user 102 or the second user 106.

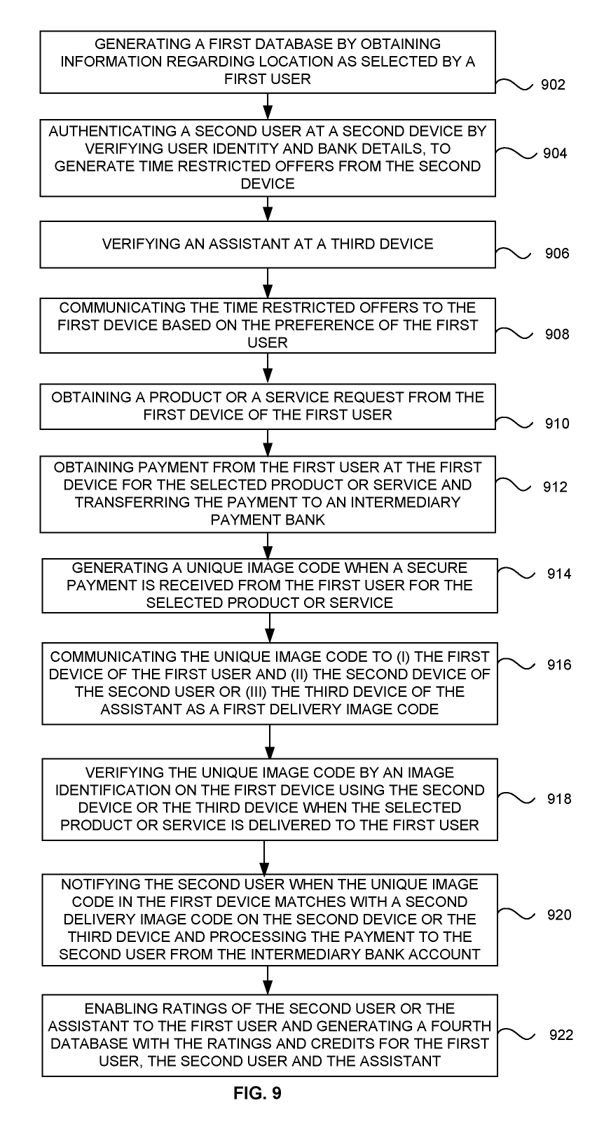

FIG. 9 illustrates a flow diagram of method enabling secure delivery and secure payment of a product or a service according to an embodiment herein. At step 902, the first database 202 is generated by obtaining information regarding location as selected by the first user 102. At step 904, the second user 106 is authenticated at the second device 102 by verifying the user identity and the bank details, to generate time restricted offers from the second device 108. At step 906, the assistant 110 is verified at the third device 112. At step 908, the time restricted offers are communicated to the first device 104 based on the preference of the first user 102. At step 910, the product or the service request is obtained from the first device 104 of the first user 102. At step 912, the payment is obtained from the first user 102 at the first device 104 for the selected product or service and transferred the payment to an intermediary payment bank. At step 914, the unique image code is generated when the secure payment is received from the first user 102 for the selected product or service. At step 916, the unique image code is communicated to (i) the first device 104 of the first user 102 and (ii) the second device 108 of the second user 106 or (iii) the third device 112 of the assistant 110 as the first delivery image code.

At step 918, the unique image code is verified by the image identification on the first device 104 using the second device 108 or the third device 112 when the selected product or service is delivered to the first user 102. At step 920, the second user 106 is notified when the unique image code in the first device 104 matches with the second delivery image code on the second device 108 or the third device 112 and the payment is processed to the second user 106 from the intermediary bank account.

At step 922, ratings of the second user 106 or the assistant 110 are enabled to the first user 102 and the fourth database 502 is generated with the ratings and credits for the first user 102, the second user 106 and the assistant 110.

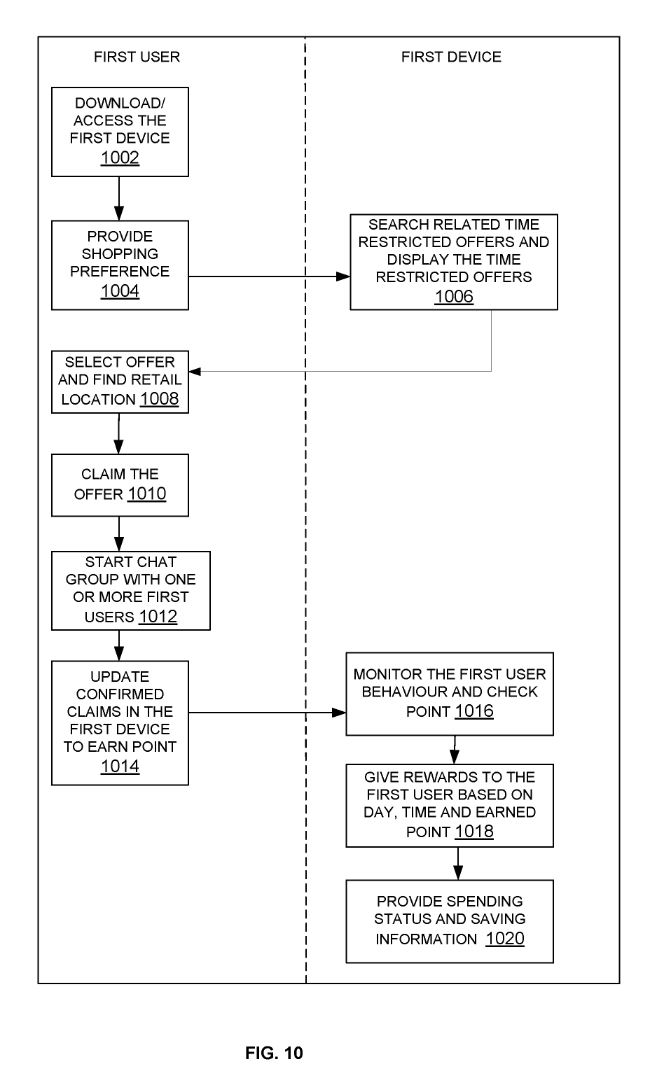

FIG. 10 is an interaction diagram illustrating a process of the first user 102 interacting with the first device 104 to an embodiment herein. At step 1002, the first user 102 downloads or accesses the first device 104. At step 1004, the first user 102 provides shopping preference in the first device 104. At step 1006, the first device 104 searches related the time restricted offers and displays the time restricted offers. At step 1008, the first user 102 selects offer and find retail location. At step 1010, the first user 102 claims the offer. At step 1012, the first user 102 starts chat group with one or more first users. At step 1014, the first user 102 updates confirmed claims in the first device 104 to earn point. At step 1016, the first device 104 monitors the first user 102 behavior and check point. At step 1018, the first device 104 provide rewards to the first user 102 based on day, time and earned point. At step 1020, the first device 104 provides spending status and saving information.

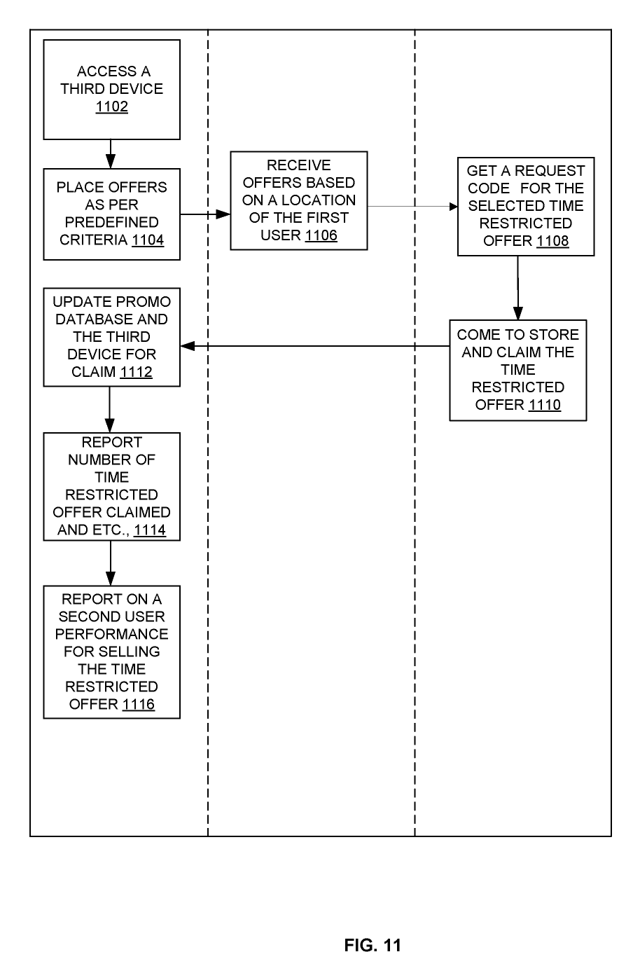

FIG. 11 is an interaction diagram illustrating a process of the assistant 110 interacting with the third device 112 to an embodiment herein. At step 1102, the assistant 110 downloads the third device 112 or access the third device 112. At step 1104, the assistant 110 places offer as per predefined criteria. At step 1106, the third device 112 receives the offer based on a location of the first user 102. At step 1108, the first user 102 gets a unique image code for the selected time restricted offer. At step 1110, the first user 102 comes to store and claim the time restricted offer. At step 1112, the assistant 110 updates promo database and the third device 112 for claiming the time restricted offer. At step 1114, the assistant 110 reports number of time restricted offer claimed and the like. At step 1116, the assistant 110 reports on a second user performance for selling the time restricted offer.

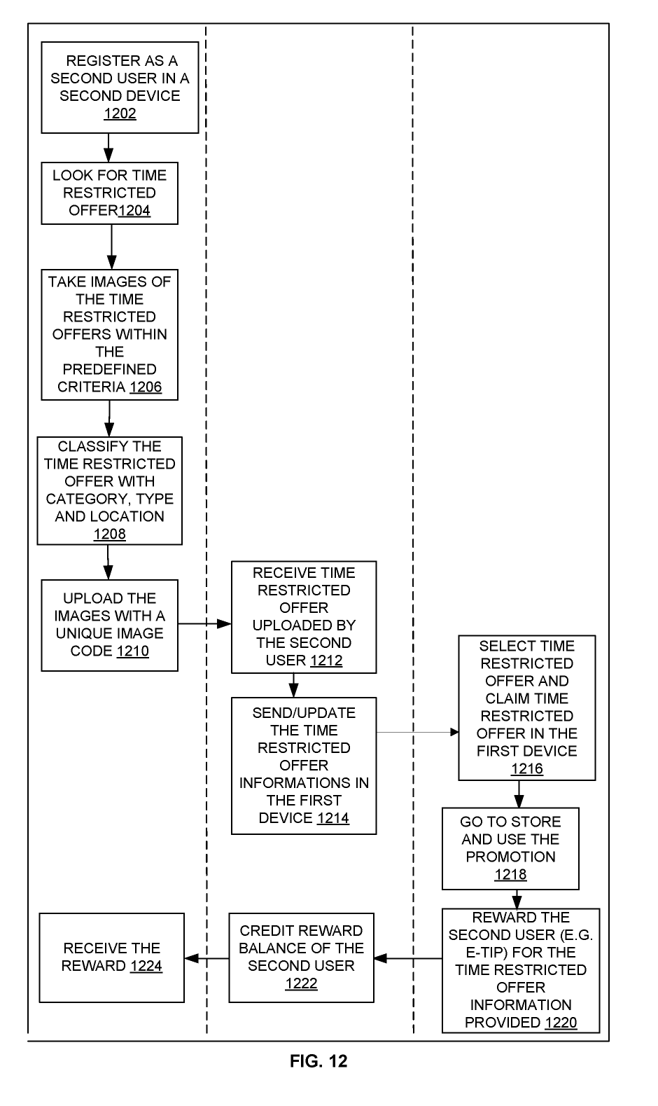

FIG. 12 is an interaction diagram illustrating a process of the second user 106 interacting with the second device 108 to an embodiment herein. At step 1202, the second user 106 registers as the second user 106. At step 1204, the second user 106 looks for time restricted offers. At step 1206, the second user 106 takes images of the time restricted offers within the predefined criteria. At step 1208, the second user 106 classifies time restricted offer with category, type and location. At step 1210, the second user 106 uploads the images with the unique image code. At step 1212, the second device 108 receive time restricted offer information uploaded by the second user 106. At step 1214, the second device 108 sends/updates the time restricted offer information in the first device 104. At step 1216, the first user 102 selects time restricted offer and claim time restricted offer in the first device 104. At step 1218, the first user 102 goes to store and use the time restricted offer. At step 1220, the first user 102 rewards the second user 106 (e.g. e-tip) for the time restricted offer information provided. At step 1222, the second device 108 credits reward balance of the second user 106. At step 1224, the second user 106 receives the reward.

The second user 106 deliveries the product with some extra delivery cost to the first user 102. The second user 106 may post the time restricted offers related to product hunt as a BID. The product or a service price suggestion from the first device 104 and displayed to the second device 108 and the third device 112 in an embodiment.

The payment server 116 enable shops can upload the window time restricted offers to the second device 108 just by few easy steps and can reach out to the living rooms of users to pamper them to come over to the shop and try time restricted offers. The bubble view is a very attractive and eye catchy way on screen, the bubble view should also be very easy for shopper to select and claim the offer or see further details.

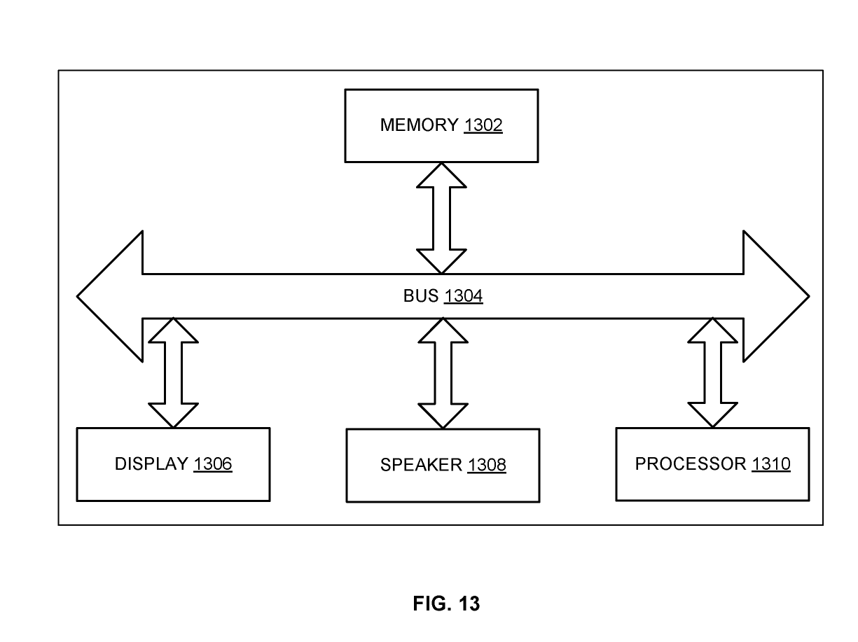

FIG. 13 illustrates an exploded view of the receiver having a memory 1302 having a set of computer instructions, a bus 1304, a display 1306, a speaker 1308, and a processor 1310 capable of processing a set of instructions to perform any one or more of the methodologies herein, according to an embodiment herein. In one embodiment, the receiver may be the personal communication device. The processor 1310 may also enable digital content to be consumed in the form of video for output via one or more displays 1306 or audio for output via speaker and/or earphones 1308. The processor 1310 may also carry out the methods described herein and in accordance with the embodiments herein.

Digital content may also be stored in the memory 1302 for future processing or consumption. The memory 1302 may also store program specific information and/or service information (PSI/SI), including information about digital content (e.g., the detected information bits) available in the future or stored from the past. A user of the personal communication device may view this stored information on display 1306 and select an item of for viewing, listening, or other uses via input, which may take the form of keypad, scroll, or other input device(s) or combinations thereof. When digital content is selected, the processor 1310 may pass information. The content and PSI/SI may be passed among functions within the personal communication device using the bus 1304.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

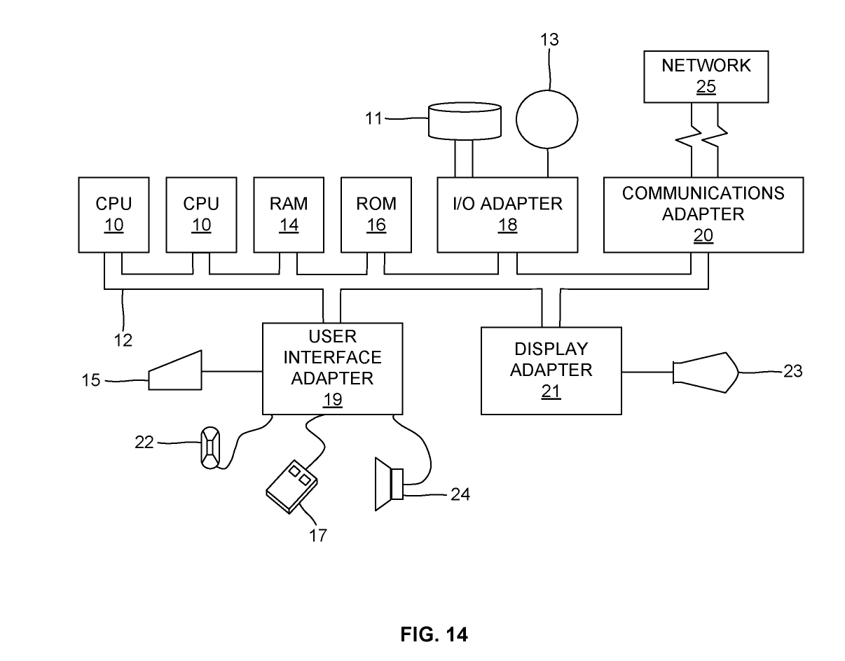

A representative hardware environment for practicing the embodiments herein is depicted in FIG. 14. This schematic drawing illustrates a hardware configuration of an information handling/computer system/payment server 116 in accordance with the embodiments herein. The payment server 116 comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor implemented method for enabling secure delivery and secure payment of a product or a service, the method comprising:
generating a first database by obtaining information regarding location as selected by a first user, wherein the first user is authenticated at a first device by verifying user identity and bank details of the first user;
authenticating a second user at a second device by verifying user identity and bank details, to generate time restricted offers from the second device, wherein an identity and bank details of at least one second user are stored at a second database of verified second users;
verifying an assistant at a third device, wherein an identity and bank details of the verified assistant are stored at a second database of verified assistants;
communicating the time restricted offers to the first device based on the preference of the first user;
obtaining a product or a service request from the first device of the first user;
obtaining payment from the first user at the first device for the selected product or service and transferring the payment to an intermediary payment bank;
generating a unique image code when a secure payment is received from the first user for the selected product or service;
communicating the unique image code to (i) the first device of the first user and (ii) the second device of the second user or (iii) the third device of the assistant as a first delivery image code;
verifying the unique image code by an image identification on the first device using the second device or the third device when the selected product or service is delivered to the first user;
notifying the second user when the unique image code in the first device matches with a second delivery image code on the second device or the third device and processing the payment to the second user from the intermediary bank account; and
enabling ratings of the second user or the assistant to the first user and generating a fourth database with the ratings and credits for the first user, the second user and the assistant.

2. The method of claim 1, wherein the method further comprises
obtaining an assistant request from the first device; and
communicating the assistant request to at least one of the third device within a selected location radius as provided by the first user when the second user do not provide secure delivery of the product or the service for the selected time restricted offer or within the selected location radius.

3. The method of claim 1, wherein the method further comprises notifying the third device and processing the payment to the verified assistant from the intermediary bank account when the unique image code matches with a second delivery image code generated on the third device.

4. The method of claim 1, wherein the method further comprises receiving the product or the service request from the first device and communicating the product or service request to at least one of (i) second device or the third device when the product or service is not available for an instant time.

5. The method of claim 1, wherein the method further comprises receiving a product or a service price suggestion from the first device and displayed to the second device and the third device.

6. The method of claim 1, wherein the method further comprises enabling the assistant to (i) edit and repost the time restricted offer or (ii) post a new time restricted offer on at least one the third device for enabling the first user to select the product or service offered by the time restricted offer, wherein the first user is in first user selected location radius or chooses to see the posts or reposts made by the assistant.

7. The method of claim 1, wherein the method further comprises reverting the unique image code to the first user when the selected product or service is not delivered by the second user or by the assistant and retaining the payment made by the first user in the intermediary bank account and the fourth database maintains a credit for the first user equal to the payment made by the first user.

8. A system of automated secure delivery and secure payment of a product or a service, the system comprising:
a memory that stores a set of instructions; and
a processor that executes the set of instructions and is configured to
generate a first database by obtaining information regarding location as selected by a first user, wherein the first user is authenticated at a first device by verifying user identity and bank details of the first user;
authenticate a second user at a second user device by verifying user identity and bank details, to generate time restricted offers from the second device, wherein an identity and bank details of the verified second users are stored at a third database of verified second users;
verify an assistant at a third device, wherein an identity and bank details of the verified assistant are stored at a third database of verified assistants;
obtain a product or a service request from the first device of the first user;
communicate the time restricted offers to the first device based on the preference of the first user;
obtain payment from the first user at the first device for the selected product or service and transfer the payment to an intermediary payment bank;
generate a unique image code when a secure payment is received from the first user for the selected product or service;
communicate the unique image code to (i) the first device of the first user and (ii) the second device of the second user or (iii) the third device of the assistant as a first delivery image code;
verify the unique image code by an image identification on the first device by the second or the third device when the selected product or service is delivered to the first user;
notify the second user when the unique image code in the first device matches with a second delivery image code on the second or the third device and processing the payment to the second user from the intermediary bank account;
enable rating of the second or the assistant by the first user and updating a fourth database with rating and credit for the first user, the second user and the assistant.

9. The system of claim 8, wherein the processor further configured to obtain an assistant request from the first device and communicate the assistant request to at least one of the third device within a selected location radius as provided by the first user when the second user do not provide secure delivery of the product or the service for the selected time restricted offer or within the selected location radius.

10. The system of claim 8, wherein the processor further configured to notify the third device and process the payment to the verified assistant from the intermediary bank account when the unique image code matches with a second delivery image code generated on the third device.

11. The system of claim 8, wherein the processor further configured to receive the product or the service request from the first device and communicate the product or service request to at least one of (i) second device or the third device when the product or service is not available for an instant time.

12. The system of claim 8, wherein the processor further configured to receive a product or a service price suggestion from the first device and displayed to the second device and the third device.

13. The system of claim 8, wherein the processor further configured to enable the assistant to (i) edit and repost the time restricted offer or (ii) post a new time restricted offer on at least one the third device for enabling the first user to select the product or service offered by the time restricted offer, wherein the first user is in first user selected location radius or chooses to see the posts or reposts made by the assistant.

14. The system of claim 8, wherein the processor further configured to revert the unique image code to the first user when the selected product or service is not delivered by the second user or by the assistant and retain the payment made by the first user in the intermediary bank account and the fourth database maintains a credit for the first user equal to the payment made by the first user.

15. One or more non-transitory computer readable storage mediums storing one or more sequences of instructions, which when executed by one or more processors, causes a processor implemented method enabling secure delivery and secure payment of a product or a service performing the steps of:
generating a first database by obtaining information regarding location as selected by a first user, wherein the first user is authenticated at a first device by verifying user identity and bank details of the first user;
authenticating a second user at a second user device by verifying user identity and bank details, to generate time restricted offers from the second device, wherein an identity and bank details of at least one second user are stored at a second database of verified second users;
verifying an assistant at a third device, wherein an identity and bank details of the verified assistant are stored at a second database of verified assistants;
communicating the time restricted offers to the first device based on the preference of the first user;
obtaining a product or a service request from the first device of the first user;
obtaining payment from the first user at the first device for the selected product or service and transferring the payment to an intermediary payment bank;
generating a unique image code when a secure payment is received from the first user for the selected product or service;
communicating the unique image code to (i) the first device of the first user and (ii) the second device of the second user or (iii) the third device of the assistant as a first delivery image code;
verifying the unique image code by an image identification on the first device using the second device or the third device when the selected product or service is delivered to the first user;
notifying the second user when the unique image code in the first device matches with a second delivery image code on the second device or the third device and processing the payment to the second user from the intermediary bank account; and
enabling ratings of the second user or the assistant to the first user and generating a fourth database with the ratings and credits for the first user, the second user and the assistant.

16. The one or more non-transitory computer readable storage mediums storing one or more sequences of instructions of claim 15, which when executed by one or more processors, further causes
obtaining an assistant request from the first device; and
communicating the assistant request to at least one of the third device within a selected location radius as provided by the first user when the second user do not provide secure delivery of the product or the service for the selected time restricted offer or within the selected location radius.

17. The one or more non-transitory computer readable storage mediums storing one or more sequences of instructions of claim 16, which when executed by one or more processors, further causes notifying the third device and process the payment to the verified assistant from the intermediary bank account when the unique image code matches with the second delivery image code generated on the third device.

18. The one or more non-transitory computer readable storage mediums storing one or more sequences of instructions of claim 15, which when executed by one or more processors, further causes receiving the product or the service request from the first device and communicating the product or service request to at least one of (i) second device or the third device when the product or service is not available for an instant time.

19. The one or more non-transitory computer readable storage mediums storing one or more sequences of instructions of claim 15, which when executed by one or more processors, further causes enabling the assistant to (i) edit and repost the time restricted offer or (ii) post a new time restricted offer on at least one the third device for enabling the first user to select the product or service offered by the time restricted offer, wherein the first user is in first user selected location radius or chooses to see the posts or reposts made by the assistant.

20. The one or more non-transitory computer readable storage mediums storing one or more sequences of instructions of claim 15, which when executed by one or more processors, further causes reverting the unique image code to the first user when the selected product or service is not delivered by the second user or by the assistant and retaining the payment made by the first user in the intermediary bank account and the fourth database maintains a credit for the first user equal to the payment made by the first user.
